(19) United States
(12) Patent Application Publication
(10) Pub. No.: US 2026/0099132 A1
(43) Pub. Date: Apr. 9, 2026

(54) HMI COPILOT

(71) Applicant: Rockwell Automation Technologies, Inc., Mayfield Heights, OH (US)

(72) Inventors: Nikhil Ashok Patange, Pune (IN); Francisco P. Maturana, Lyndhurst, OH (US); Krutika Kansara, Maharashtra (IN)

(21) Appl. No.: 18/910,205

(22) Filed: Oct. 9, 2024

Related U.S. Application Data
(60) Provisional application No. 63/595,021, filed on Nov. 1, 2023.

(51) Int. Cl. G05B 19/409; G05B 19/4063

(52) U.S. Cl. CPC G05B 19/409; G05B 19/4063; G05B 2219/32351; G05B 2219/36133

(57) ABSTRACT

A human-machine interface (HMI) development and runtime system leverages generative artificial intelligence (AI) to create HMI dashboards or graphical interfaces without the need for manual coding based on natural language prompts submitted by the user, which specify the information the user wishes to see. In one or more embodiments, the system can support industry-specific prompt engineering services that assist a user in generating a customized HMI dashboard that satisfies specified criteria using natural language prompts that describe functional and visual requirements of the dashboard. The system can make use of a generative AI model and associated neural networks to generate suitable dashboards in accordance with functional requirements provided to the system as intuitive natural language inputs (e.g., spoken or written natural language text).

### CROSS-REFERENCE TO RELATED APPLICATIONS

This application claims priority to U.S. Provisional Patent Application Ser. No. 63/595,021, filed on Nov. 1, 2023, and entitled “GENERATIVE AI INDUSTRIAL APPLICATIONS,” the entirety of which is incorporated herein by reference.

### TECHNICAL FIELD

The subject matter disclosed herein relates generally to industrial automation systems, and, for example, to industrial human-machine interface (HMI) design and runtime platforms

### BACKGROUND ART

Industrial human-machine interfaces, or HMIs, typically comprise a computer terminal with display capabilities that executes an HMI runtime application, which defines the display screens that are presented to the operator of an industrial automation system, the navigation structure for navigating between the display screens, and the data links or bindings between the graphical elements and corresponding data tags in the controller's data table. HMI developers typically design these aspects of an HMI using an HMI development platform. These HMI development platforms typically support a graphical and menu-driven development workflow in which the developer selects graphical display and control elements from a library of elements for inclusion on each display interface, manipulates these selected elements—e.g., via drag-and-drop interactions—on a mock-up of the display interface to yield a desired layout, and writes any additional code necessary to control the visual behaviors of these elements or to otherwise control the content presented by the HMI during runtime.

### BRIEF DESCRIPTION

The following presents a simplified summary in order to provide a basic understanding of some aspects described herein. This summary is not an extensive overview nor is intended to identify key/critical elements or to delineate the scope of the various aspects described herein. Its sole purpose is to present some concepts in a simplified form as a prelude to the more detailed description that is presented later.

In one or more embodiments, a system is provided, comprising a user interface component configured to render a chat interface on a client device and to receive, via interaction with the chat interface, a natural language prompt that describes a visualization requirement for rendering operational or status information about an industrial automation system; a generative artificial intelligence (AI) component configured to, in response to receipt of the natural language prompt, formulate a human-machine interface (HMI) dashboard that satisfies the visualization requirement based on analysis of the natural language prompt and content of one or more custom models trained with training data, wherein the HMI dashboard defines a display screen, a layout of graphical objects on the display screen, and communication links between the graphical objects and corresponding sources of data generated by an industrial automation system; an HMI generation component configured to render the HMI dashboard on the client device; and a device interface component configured to read data from the sources of data and visualize the data on the HMI dashboard via the graphical objects.

Also, one or more embodiments provide a method, comprising rendering, by a system comprising a processor, a chat interface on a client device; receiving, by the system via interaction with the chat interface, a natural language prompt describing a visualization requirement for rendering operational or status information about an industrial automation system; in response to the receiving of the natural language prompt, formulating, by the system, a human-machine interface (HMI) dashboard that satisfies the visualization requirement based on analysis of the natural language prompt and content of one or more custom models trained with training data, wherein the HMI dashboard defines a display screen, a layout of graphical objects on the display screen, and communication links between the graphical objects and corresponding sources of data generated by an industrial automation system; rendering, by the system, the HMI dashboard on the client device; and rendering, by the system, data items read from the sources of data on the HMI dashboard via the graphical objects.

Also, according to one or more embodiments, a non-transitory computer-readable medium is provided having stored thereon instructions that, in response to execution, cause a system to perform operations, the operations comprising rendering a chat interface on a client device; receiving, via interaction with the chat interface, a natural language prompt describing a visualization requirement for rendering operational or status information about an industrial automation system; in response to the receiving of the natural language prompt, formulating a human-machine interface (HMI) dashboard that satisfies the visualization requirement based on analysis of the natural language prompt and content of one or more custom models trained with training data, wherein the HMI dashboard defines a display screen, a layout of graphical objects on the display screen, and communication links between the graphical objects and corresponding sources of data generated by an industrial automation system; rendering the HMI dashboard on the client device; and rendering data items read from the sources of data on the HMI dashboard via the graphical objects.

To the accomplishment of the foregoing and related ends, certain illustrative aspects are described herein in connection with the following description and the annexed drawings. These aspects are indicative of various ways which can be practiced, all of which are intended to be covered herein. Other advantages and novel features may become apparent from the following detailed description when considered in conjunction with the drawings.

### BRIEF DESCRIPTION OF THE DRAWINGS

FIG. 1 is a block diagram of an example industrial control environment.

FIG. 2 is a diagram of a generalized architecture including an industrial controller and an HMI.

FIG. 3 is a block diagram of an example HMI development and runtime system.

FIG. 4 is a diagram illustrating generative AI-assisted HMI design and creation using the HMI development and runtime system.

FIG. 5 is a diagram illustrating training of the custom models used by the system's generative AI component.

FIG. 6 is a diagram illustrating delivery of an animated HMI dashboard to an HMI terminal or client device.

FIG. 7 is an example display that can be generated by the system and rendered on an HMI terminal device or a user's client device for invoking and viewing an HMI dashboard.

FIG. 8a is a flowchart of a first part of an example methodology for generating an HMI dashboard or interface using natural language design input.

FIG. 8b is a flowchart of a second part of the example methodology for generating an HMI dashboard or interface using natural language design input.

FIG. 9 is an example computing environment.

FIG. 10 is an example networking environment.

### DETAILED DESCRIPTION

The subject disclosure is now described with reference to the drawings, wherein like reference numerals are used to refer to like elements throughout. In the following description, for purposes of explanation, numerous specific details are set forth in order to provide a thorough understanding thereof. It may be evident, however, that the subject disclosure can be practiced without these specific details. In other instances, well-known structures and devices are shown in block diagram form in order to facilitate a description thereof.

As used in this application, the terms “component,” “system,” “platform,” “layer,” “controller,” “terminal,” “station,” “node,” “interface” are intended to refer to a computer-related entity or an entity related to, or that is part of, an operational apparatus with one or more specific functionalities, wherein such entities can be either hardware, a combination of hardware and software, software, or software in execution. For example, a component can be, but is not limited to being, a process running on a processor, a processor, a hard disk drive, multiple storage drives (of optical or magnetic storage medium) including affixed (e.g., screwed or bolted) or removable affixed solid-state storage drives; an object; an executable; a thread of execution; a computer-executable program, and/or a computer. By way of illustration, both an application running on a server and the server can be a component. One or more components can reside within a process and/or thread of execution, and a component can be localized on one computer and/or distributed between two or more computers. Also, components as described herein can execute from various computer readable storage media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry which is operated by a software or a firmware application executed by a processor, wherein the processor can be internal or external to the apparatus and executes at least a part of the software or firmware application. As yet another example, a component can be an apparatus that provides specific functionality through electronic components without mechanical parts, the electronic components can include a processor therein to execute software or firmware that provides at least in part the functionality of the electronic components. As further yet another example, interface(s) can include input/output (I/O) components as well as associated processor, application, or Application Programming Interface (API) components. While the foregoing examples are directed to aspects of a component, the exemplified aspects or features also apply to a system, platform, interface, layer, controller, terminal, and the like.

As used herein, the terms “to infer” and “inference” refer generally to the process of reasoning about or inferring states of the system, environment, and/or user from a set of observations as captured via events and/or data. Inference can be employed to identify a specific context or action, or can generate a probability distribution over states, for example. The inference can be probabilistic-that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

In addition, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

Furthermore, the term “set” as employed herein excludes the empty set; e.g., the set with no elements therein. Thus, a “set” in the subject disclosure includes one or more elements or entities. As an illustration, a set of controllers includes one or more controllers; a set of data resources includes one or more data resources; etc. Likewise, the term “group” as utilized herein refers to a collection of one or more entities; e.g., a group of nodes refers to one or more nodes.

Various aspects or features will be presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches also can be used.

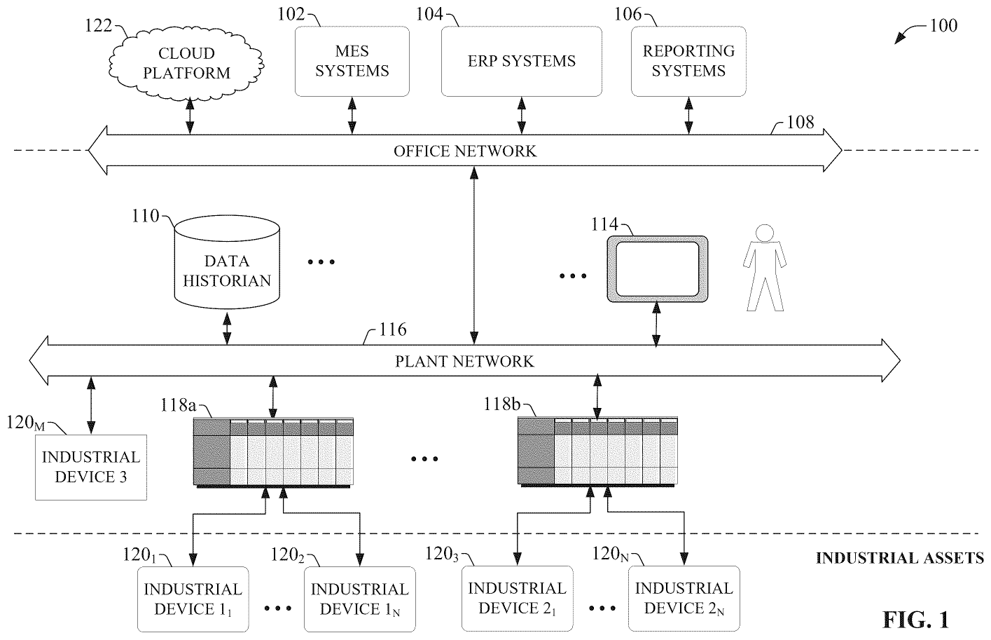

FIG. 1 is a block diagram of an example industrial control environment 100. In this example, a number of industrial controllers 118 are deployed throughout an industrial plant environment to monitor and control respective industrial systems or processes relating to product manufacture, machining, motion control, batch processing, material handling, or other such industrial functions. Industrial controllers 118 typically execute respective control programs to facilitate monitoring and control of industrial devices 120 making up the controlled industrial assets or systems (e.g., industrial machines). One or more industrial controllers 118 may also comprise a soft controller executed on a personal computer or other hardware platform, or on a cloud platform. Some hybrid devices may also combine controller functionality with other functions (e.g., visualization). The control programs executed by industrial controllers 118 can comprise any conceivable type of code used to process input signals read from the industrial devices 120 and to control output signals generated by the industrial controllers, including but not limited to ladder logic, sequential function charts, function block diagrams, or structured text.

Industrial devices 120 may include both input devices that provide data relating to the controlled industrial systems to the industrial controllers 118, and output devices that respond to control signals generated by the industrial controllers 118 to control aspects of the industrial systems. Example input devices can include telemetry devices (e.g., temperature sensors, flow meters, level sensors, pressure sensors, etc.), manual operator control devices (e.g., push buttons, selector switches, etc.), safety monitoring devices (e.g., safety mats, safety pull cords, light curtains, etc.), and other such devices. Output devices may include motor drives, pneumatic actuators, signaling devices, robot control inputs, valves, and the like. Some industrial devices, such as industrial device 120_{M}, may operate autonomously on the plant network 116 without being controlled by an industrial controller 118.

Industrial controllers 118 may communicatively interface with industrial devices 120 over hardwired or networked connections. For example, industrial controllers 118 can be equipped with native hardwired inputs and outputs that communicate with the industrial devices 120 to effect control of the devices. The native controller I/O can include digital I/O that transmits and receives discrete voltage signals to and from the field devices, or analog I/O that transmits and receives analog voltage or current signals to and from the devices. The controller I/O can communicate with a controller's processor over a backplane such that the digital and analog signals can be read into and controlled by the control programs. Industrial controllers 118 can also communicate with industrial devices 120 over the plant network 116 using, for example, a communication module or an integrated networking port. Exemplary networks can include the Internet, intranets, Ethernet, DeviceNet, ControlNet, Data Highway and Data Highway Plus (DH/DH+), Remote I/O, Fieldbus, Modbus, Profibus, wireless networks, serial protocols, and the like. The industrial controllers 118 can also store persisted data values that can be referenced by the control program and used for control decisions, including but not limited to measured or calculated values representing operational states of a controlled machine or process (e.g., tank levels, positions, alarms, etc.) or captured time series data that is collected during operation of the automation system (e.g., status information for multiple points in time, diagnostic occurrences, etc.). Similarly, some intelligent devices - including but not limited to motor drives, instruments, or condition monitoring modules - may store data values that are used for control and/or to visualize states of operation. Such devices may also capture time-series data or events on a log for later retrieval and viewing.

Industrial automation systems often include one or more human-machine interface (HMIs) terminals 114 that allow plant personnel to view telemetry and status data associated with the automation systems, and to control some aspects of system operation. HMI terminals 114 may communicate with one or more of the industrial controllers 118 over a plant network 116, and exchange data with the industrial controllers to facilitate visualization of information relating to the controlled industrial processes on one or more pre-developed operator interface screens. HMI terminals 114 can also be configured to allow operators to submit data to specified data tags or memory addresses of the industrial controllers 118, thereby providing a means for operators to issue commands to the controlled systems (e.g., cycle start commands, device actuation commands, etc.), to modify setpoint values, etc. HMI terminals 114 execute HMI runtime applications that generate one or more display screens through which the operator interacts with the industrial controllers 118, and thereby with the controlled processes and systems. Example display screens can visualize present states of industrial systems or their associated devices using graphical representations of the processes that display metered or calculated values, employ color or position animations based on state, render alarm notifications, or employ other such techniques for presenting relevant data to the operator. Data presented in this manner is read from industrial controllers 118 by HMI terminals 114 and presented on one or more of the display screens according to display formats chosen by the HMI developer. HMI terminals 114s may comprise fixed location or mobile devices with either user-installed or pre-installed operating systems, and either user-installed or pre-installed graphical application software.

Some industrial environments may also include other systems or devices relating to specific aspects of the controlled industrial systems. These may include, for example, one or more data historians 110 that aggregate and store production information collected from the industrial controllers 118 and other industrial devices.

Industrial devices 120, industrial controllers 118, HMI terminals 114, associated controlled industrial assets, and other plant-floor systems such as data historians 110, vision systems, and other such systems operate on the operational technology (OT) level of the industrial environment. Higher level analytic and reporting systems may operate at the higher enterprise level of the industrial environment in the information technology (IT) domain; e.g., on an office network 108 or on a cloud platform 122. These higher level systems can include, for example, enterprise resource planning (ERP) systems 104 that integrate and collectively manage high-level business operations, such as finance, sales, order management, marketing, human resources, or other such business functions. Manufacturing Execution Systems (MES) 102 can monitor and manage control operations on the control level in view of higher-level business considerations, driving those control-level operations toward outcomes that satisfy defined business goals (e.g., order fulfillment, resource tracking and management, asset utilization tracking, etc.). Reporting systems 106 can collect operational data from industrial devices on the plant floor and generate daily or shift reports that summarize operational statistics of the controlled industrial assets.

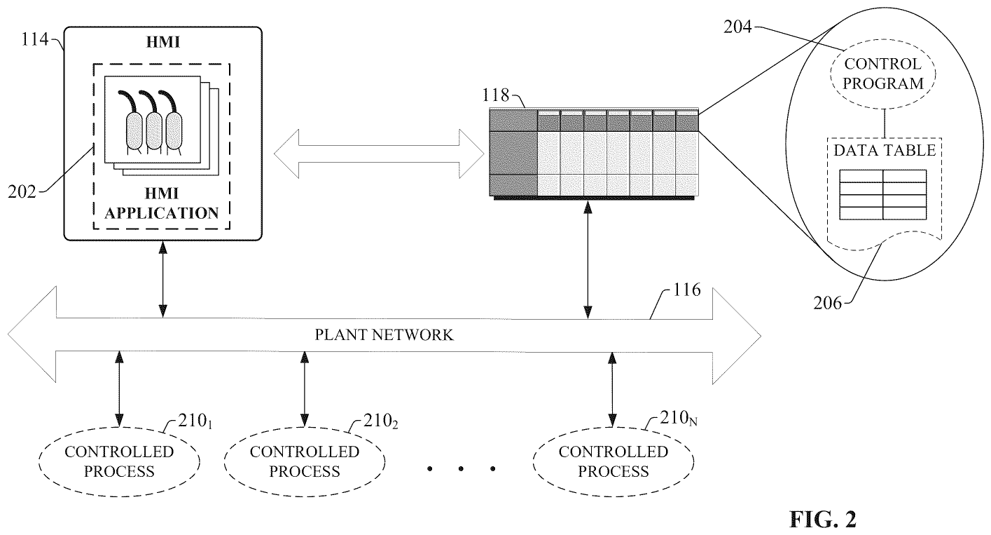

FIG. 2 is a diagram of a generalized architecture including an industrial controller 118 and an HMI terminal 114. An industrial facility can comprise one or more controlled processes 210₁-210_{N} relating to product manufacture, machining, motion control, batch processing, material handling, or other such industrial functions. As noted above, the devices and machines that carry out the processes 210₁-210_{N} (e.g., devices 120 of FIG. 1 and their associated machines) can be monitored and controlled by an industrial controller 118, which executes a control program 204 to facilitate monitoring and control of controlled processes 210₁-210_{N}. Control program 204 can be substantially any type of code used to process input signals read into the controller 118 and to control output signals from the controller 118, including but not limited to ladder logic programming, sequential function charts, function block diagrams, or structured text. Data read into or generated by controller 118 can be stored in a data table 206 within the controller's memory.

Controller 118 can exchange data with the input and output devices of the controlled processes 210₁-210_{N} over the plant network 116, or over another hardwired or networked connection. For example, controller 118 can be equipped with native hardwired input and output points that exchange digital and analog signals with the field devices to effect control of the devices. The native controller I/O can include digital I/O that transmits and receives discrete voltage signals to and from the field devices, or analog I/O that transmits and receives analog voltage or current signals to and from the devices. The controller 118 translates input signals from the controlled processes 210 into digital and analog data values, which are stored in the controller's data table 206. The control program 204 processes these input data values in accordance with a user-defined control algorithm and sets values of the controller's digital and analog output signals based on this processing. The values of the output signals, and any other values calculated by the control program 204, are stored in the data table 206.

HMI terminal 114 leverages data stored in the controller's data table 206 to visualize information relating to the controlled processes 210₁-210_{N} as graphical and alphanumeric information. To this end, the HMI terminal 114 communicates with the controller 118 via the plant network 116 or via a direct connection, and reads data from and writes data to the data table 206 over this connection. The HMI terminal 114 renders navigable interface display screens that present current operational or status information for the controlled processes 210₁-210_{N}. In some implementations, the display screens can render graphical representations of the machines that carry out the controlled processes 210₁-210_{N}, and can animate these graphical representations based on the current statuses of the corresponding machines, as determined based on the data values contained in the controller's data table 206. These animations can include, for example, setting a color of a graphical element based on a state of a corresponding machine component, altering the height of a fill graphic based on a corresponding fill level of a tank, setting a position or orientation of a graphical element based on a corresponding position or orientation of a machine component, displaying alphanumeric text conveying metered values (e.g., temperatures, pressures, flows, etc.), or other such animations.

Operators can also interact with the HMI's display screens to send commands to the controller 118 that alter operation of the controlled processes 210₁-210_{N}. These commands can include, for example, altering control setpoints, initiating start or stop commands, changing an operating mode of a machine or process, clearing alarm messages render by the HMI terminal 114, or other such commands. To provide a means to issue these commands, the display screens can include interactive graphical controls - such as graphical pushbuttons, data entry fields, or other such controls - that are linked to corresponding data tags defined in the data table 206. Through interaction with these controls, the operator can write digital or analog values to these data tags, and these values are processed by the control program 204 in connection with controlling the industrial processes 210₁-210_{N}.

In general, an HMI comprises an HMI terminal 114 with display capabilities that executes an HMI runtime application 202. The HMI runtime application 202 defines the display screens that are presented to the operator (including definitions of the graphical elements and controls included on each display screen and the arrangements of those elements), the navigation structure for navigating between the display screens, and the data links or bindings between the graphical elements and corresponding data tags in the controller's data table 206. HMI developers typically design these aspects of an HMI using an HMI development platform, which compiles the design into an HMI runtime application 202 that can be downloaded to, and executed on, the HMI terminal. These HMI development platforms typically support a graphical and menu-driven development workflow, in which the developer selects graphical display and control elements from a library of elements for inclusion on each display interface, and manipulates these selected elements—e.g., via drag-and-drop interactions—on a mock-up of the display interface to yield a desired layout. For elements whose appearance or behavior is a function of a value of a data tag defined in the controller's data table 206, the developer typically defines the binding to the appropriate data tag by invoking the element's properties window and specifying the data tag in an appropriate property field of the window. Similarly, for elements designed to write data to the controller 118—such as graphical pushbuttons and data entry fields—users typically set the data tags to which those elements write their data via interaction with the elements'properties windows. This graphical development approach can also be cumbersome and time-consuming.

Moreover, engineers often find the process of visualizing and integrating diverse system data from multiple different sources into a cohesive HMI dashboard or interface challenging. Customization of such dashboards for different manufacturing processes can also produce design bottlenecks, hindering real-time decision-making. Modern manufacturing requires agile and data-driven decision-making, necessitating smarter and faster HMI dashboard creation methods.

To address these and other issues, one or more embodiments described herein provide an HMI development and runtime system that leverages generative AI to create HMI dashboards or graphical interfaces without the need for manual coding based on natural language prompts submitted by the user, which specify the information the user wishes to see. In one or more embodiments, system can support industry-specific prompt engineering services that assist a user in generating a customized HMI dashboard that satisfies specified criteria using natural language prompts that describe functional and visual requirements of the dashboard. To this end, the system can make use of a generative AI model and associated neural networks to generate suitable dashboards - including display screen content and layouts, screen navigational structures, links between animated graphics and data sources such as controller data tags, alarm definitions, color settings, and other such aspects - in accordance with functional requirements provided to the HMI development system as intuitive natural language inputs (e.g., spoken or written natural language text). Some embodiments of the HMI development system can include a specialized prompt engineering layer and associated custom models—trained using knowledge of various types of industrial control applications, knowledge of specific types of industrial assets, vertical-specific industrial standards and best practices, sample HMI layouts, and other such training data—that generate prompts or meta-prompts based on a user's natural language inputs for submission to generative AI models such as large language models (LLMs).

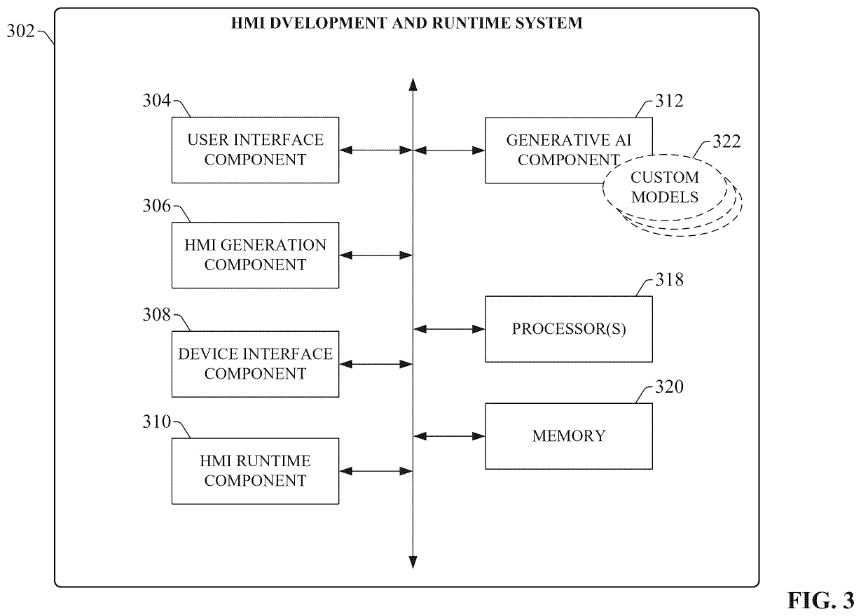

FIG. 3 is a block diagram of an example HMI development and runtime system 302 according to one or more embodiments of this disclosure. Aspects of the systems, apparatuses, or processes explained in this disclosure can constitute machine-executable components embodied within machine(s), e.g., embodied in one or more computer-readable mediums (or media) associated with one or more machines. Such components, when executed by one or more machines, e.g., computer(s), computing device(s), automation device(s), virtual machine(s), etc., can cause the machine(s) to perform the operations described.

HMI development and runtime system 302 can include a user interface component 304, an HMI generation component 306, a device interface component 308, an HMI runtime component 310, a generative AI component 312, one or more processors 318, and memory 320. In various embodiments, one or more of the user interface component 304, HMI generation component 306, device interface component 308, HMI runtime component 310, generative AI component 312, the one or more processors 318, and memory 320 can be electrically and/or communicatively coupled to one another to perform one or more of the functions of the HMI development and runtime system 302. In some embodiments, components 304, 306, 308, 310, and 312 can comprise software instructions stored on memory 320 and executed by processor(s) 318. HMI development and runtime system 302 may also interact with other hardware and/or software components not depicted in FIG. 3. For example, processor(s) 318 may interact with one or more external user interface devices, such as a keyboard, a mouse, a display monitor, a touchscreen, or other such interface devices.

User interface component 304 can be configured to receive user input and to render output to the user in any suitable format (e.g., visual, audio, tactile, etc.). In some embodiments, user interface component 304 can be configured to generate and serve interface displays, such as chat interface displays, to a client device, and exchange data via these interface displays. Input data that can be received via various embodiments of user interface component 304 can include, but is not limited to, natural language inputs specifying design requirements for an HMI to be used to visualize operational and status information for an industrial automation system. Output data rendered by various embodiments of user interface component 304 can include, but is not limited to, customized dashboards designed to visualize live and historical data generated by an industrial automation system or process, natural language responses to natural language prompts submitted by a user, or other such output data.

HMI generation component 306 can be configured to generate an HMI application or dashboard based on natural language design specifications submitted by a user. Device interface component 308 can be configured to receive data generated by industrial devices associated with an industrial automation system (e.g., industrial controllers 118 or other industrial devices) during operation of the automation system. Device interface component 308 can retrieve this data from various data sources, including the industrial devices themselves, controller emulators, repositories of archived historical data, or other such sources. HMI runtime component 310 can be configured to execute a runtime version of the HMI application or dashboard generated by the HMI generation component 306.

Generative AI component 312 can be configured to assist the HMI generation component 306 in creating the HMI application or dashboard based on the user's design specifications, and to assist the HMI runtime component 310 in extracting data insights for presentation on the HMI dashboard during runtime. To this end, the generative AI component 312 can implement prompt engineering functionality using associated custom models 322 trained with domain-specific industrial training data, using these models 322 to generate and submit prompts to a generative AI model and associated neural networks in connection with determining the design requirements of the HMI application from the user's natural language inputs, generating an HMI dashboard that satisfies these design requirements, and extracting relevant insights from runtime data collected from the devices that make up the corresponding automation system.

The one or more processors 318 can perform one or more of the functions described herein with reference to the systems and/or methods disclosed. Memory 320 can be a computer-readable storage medium storing computer-executable instructions and/or information for performing the functions described herein with reference to the systems and/or methods disclosed.

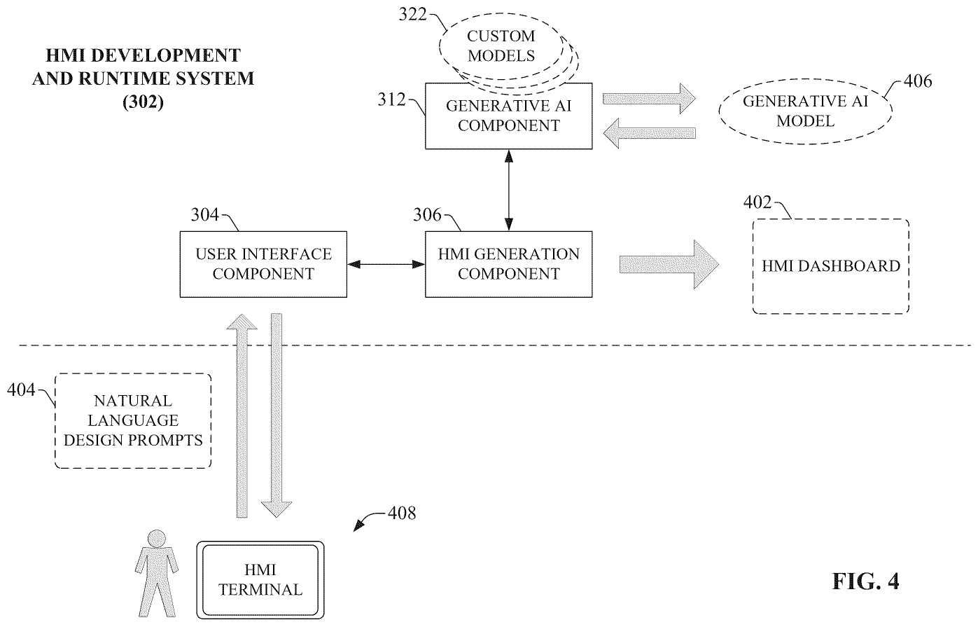

FIG. 4 is a diagram illustrating generative AI-assisted HMI design and creation using the HMI development and runtime system 302. Some embodiments of the HMI development and runtime system 302 can be implemented on a cloud platform and made accessible to multiple industrial customers having authorized access to use the system's services. Alternatively, some embodiments of HMI development and runtime system 302 may execute at least partially on a local client device while accessing remote services and repositories as needed.

In general, when an industrial automation system or its associated controlled process 210 experiences an abnormal condition, traditional HMIs are limited in their ability to assist with root cause analysis, since these HMIs require a priori knowledge of the automation system's components and construction—e.g., moving parts of the automation system's machinery, control devices that monitor or control the automation system, the type of industrial application carried out by the automation system, etc.—at the time that the HMI interfaces are designed. The necessity to anticipate the visualization requirements of the automation system during the HMI's design phase can limit the resulting HMI's ability to visualize useful information about unexpected ad hoc conditions experienced by the automation system and to extract insights about these conditions from available data. Moreover, traditional HMIs offer only reactive views of automation system data, in the form of pre-designed and pre-formatted visualization content, and do not have the ability to discover other relationships and insights beyond those presented on the predefined HMI displays.

To address these issues, the HMI development and runtime system 302 can leverage generative AI to create HMI dashboards 402 without manual coding based on natural language prompts 404 submitted by the user, which specify the information the user wishes to see. In the example architecture depicted in FIG. 4, an HMI terminal device 408 is configured to remotely interface and exchange data with the system 302 via the system's user interface component 304. However, other types of client devices can also be configured to interface with the system 302, including but not limited to laptop computers, tablet computers, desktop computers, mobile handheld devices, wearable augmented reality or virtual reality appliances, or other such devices. Through interactions with the HMI terminal device 408 or another client device, a user can submit natural language design prompts 404 to the system 302 for processing. For example, some embodiments of the HMI development and runtime system 302 can render a chat-based interface on the HMI terminal device 408 through which the user can submit text-based or verbal natural language prompts 404 to the system 302. The system's natural language processing services can leverage generative AI to assist the user in dynamically creating, editing, or customizing HMI dashboards 402 for visualizing data from monitoring and control devices of an industrial automation system.

While the examples illustrated herein depict these prompts 404 being submitted via an HMI terminal device 408 which will typically be located near the automation system being visualized, the system 302 also allows a user to create and invoke dashboards 402 that visualize information from an automation system at remote locations via submission of natural language prompts 404, which can be submitted via the user's personal client device regardless of the user's proximity to the automation system being visualized.

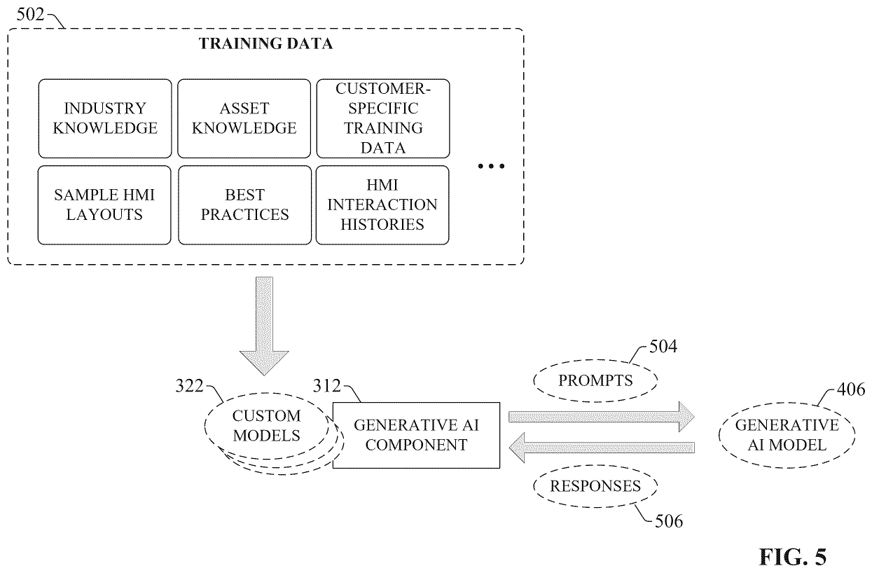

As noted above, the HMI development and runtime system 302 can leverage generative AI to assist with dynamic creation of HMI dashboards in accordance with a user's natural language prompts 404, including intelligent selection and formatting of dashboard content, selection of data sources to which the dashboard's graphical elements are to be linked, and other dashboard creation tasks. To this end, the system's generative AI component 312 can implement prompt engineering functionality using associated custom models 322 trained with domain-specific industrial training data, and can interface with a generative AI model 406 (e.g., an LLM or another type of model) and associated neural networks. FIG. 5 is a diagram illustrating training of the custom models 322 used by the generative AI component 312. In some embodiments, the generative AI model 406 can reside and execute externally from the HMI development and runtime system 302, and the generative AI component 312 can include suitable connectivity tools and protocols, application programming interfaces (APIs), or other such services that allow the generative AI component 312 to exchange prompts and responses with the generative AI model 406.

Custom models 322 can be trained using sets of training data 502 representing a range of domain-specific industrial knowledge, as well as customer-specific knowledge, that can assist the generative AI component 312 in generating or modifying HMI dashboards 402 having a high probability of satisfying a user's visualization requirements—as conveyed via natural language prompts 404—as well as satisfying any application-specific or vertical-specific requirements.

Example training data 502 that can be used to train the custom models 322 includes, but is not limited to, information defining industrial standards (e.g., global or vertical-specific safety standards, food and drug standards, design standards such as the ISA-88 standard, etc.), technical specifics or design standards for various types of industrial control applications (e.g., batch control processes, die casting, valve control, agitator control, etc.), knowledge of specific industrial verticals (e.g., automotive, food and beverage, pharmaceuticals, oil and gas, textiles, mining, etc.), knowledge of industrial best practices, technical specifications for various types of industrial devices or assets (e.g., industrial controllers, motor drives such as variable frequency drives, sensors, etc.), control design rules, sample HMI display layouts for various types of control applications or use cases, customer-specific training data describing in-house HMI design preferences or standards (e.g., preferred screen layout formats, preferred types of graphics, preferred text fonts, etc.), customer-specific information regarding plant locations operated by the customer and the industrial systems in service at the respective locations, or other such training data.

When a natural language prompt 404 requesting creation of an HMI dashboard 402 having specified characteristics is received, the generative AI component 312 can, as needed, formulate and submit prompts 504 to the generative AI model 406 designed to obtain responses 506 that assist the HMI generation component 306 to create a suitable dashboard 402 that satisfies the criteria specified by the user's prompt 404. These prompts 504 are generated based on content of the user's natural language prompt 404 as well as the industry knowledge and reference data encoded in the trained custom models 322. The generative AI component 312 can reference custom models 322 as needed in connection with processing a user's natural language prompts 404 or queries and prompting the generative AI model 406 for responses 506 that assist the HMI generation component 306 in processing these requests and queries.

Returning to FIG. 4, in an example scenario, a user may request, via a natural language prompt 404, an HMI dashboard 402 that plots data from a specified sensor associated with a machine or production line at a particular plant. The prompt 404 may specify the plant location (if the industrial enterprise with which the user is associated operates multiple plant facilities), the machine or line, and the sensor or data item to be plotted. In response to receipt of this prompt 404, the HMI generation component 306, assisted by generative AI component 312, can create a dashboard 402 that satisfies the request conveyed by the prompts 404.

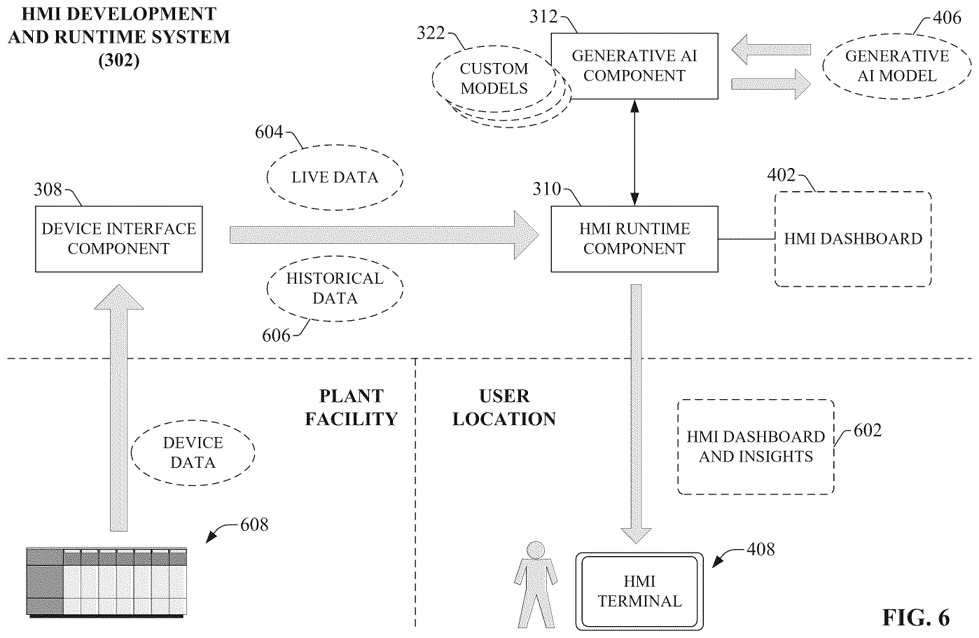

The system 302 can then render a view of this dashboard 402 on the HMI terminal 408 or client device, animated by the real-time or historical data requested by the user. FIG. 6 is a diagram illustrating delivery of the animated HMI dashboard 602 to the HMI terminal 408 or client device. The system's device interface component 308 monitors and collects device data—including live or real-time data 604 as well as historical data 606—generated by industrial devices 608 of various automation systems and machines, including systems across multiple geographic locations. After the HMI generation component 306 has generated an HMI dashboard 402 in accordance with the user's natural language prompt 404, the HMI runtime component 310 renders a runtime version of the dashboard 602 on the HMI terminal device 408 (or the user's personal client device if the prompt 404 was submitted via the client device) and populates this runtime dashboard 602 using a subset of the live data 604 and/or historical data 606 deemed necessary to satisfy the user's request as conveyed by the prompt 404. The HMI runtime component 310 and the generative AI component 312 can also extract, from the device data 604 and 606, insights and relationships determined to be relevant to the user's request and render these insights on the runtime dashboard 602.

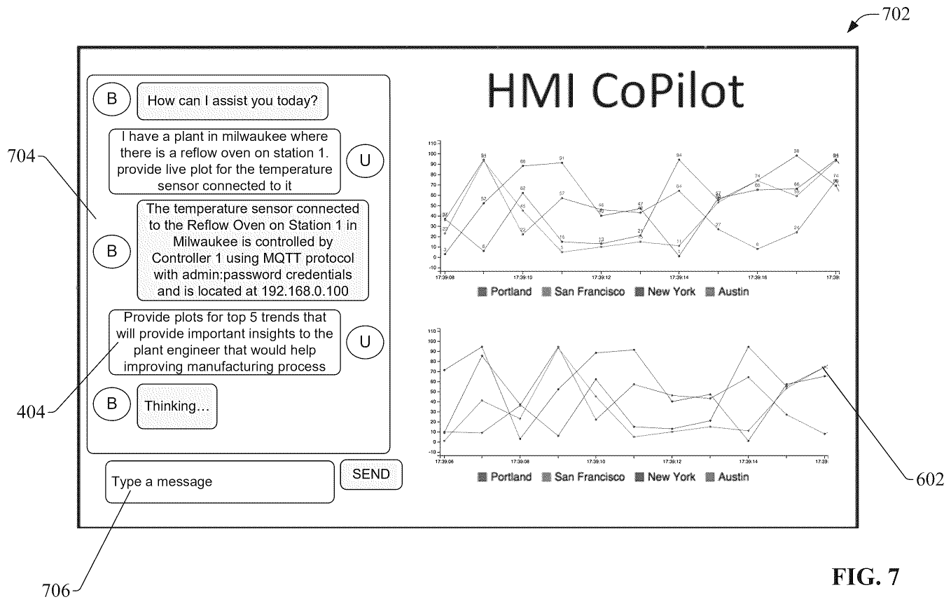

FIG. 7 is an example display 702 that can be generated by the system's user interface component 304 and rendered on an HMI terminal device 408 or a user's client device for invoking and viewing an HMI dashboard 602 generated by the HMI development and runtime system 302. This example display 702 includes a prompt field 706 in which the user can enter natural language prompts 404 requesting a dashboard for visualizing a specified set of device data 604, 606. Although the example display 702 depicts a prompt field 706 that supports entry of text-based prompts 404, some embodiments of display 702 can also allow a user to submit prompts 404 as spoken word input, which are converted to text and processed by the system 302. A chat window 704 above the prompt field 706 displays the user's submitted prompts 404 and the system's responses as a chat dialog.

For example, the user may submit a prompt 404 stating “I have a plant in Milwaukee where there is a reflow over on station 1. Provide live plot for the temperature sensor connected to it.” The HMI generation component 306, leveraging the generative AI component 312 and the generative AI model 406, can respond to this prompt 404 by dynamically generating the requested plot as a dashboard 602, and the HMI runtime component 310 can render this dashboard 602 on the right side of the display 702. The generative AI component 312 can also respond to the prompt 404 with additional insights about the operation of the customer's industrial assets deemed relevant to the user's request based on analysis of the prompt 404, the available device data 604, 606, and any relevant responses 506 prompted from the generative AI model 406 by the generative AI component 312. These additional insights can be rendered as natural language responses in the chat window 704 (e.g., “The temperature sensor connected to the Reflow Oven on Station 1 in Milwaukee is controlled by the Controller 1 using MQTT protocol with admin: password credentials and is located at 192.168.0.100”). Example insights or supplemental information that can be determined and rendered by the system 302 can include, for example, functional relationships between industrial assets (e.g., an identity of an industrial controller that controls a process that is the subject of the user's prompt 404, an identity of a first machine that provides components or materials to a second machine, etc.), an identity of a sensor or meter that provides the data requested by the user's prompt 404, a communication protocol used for data communication between two industrial devices or assets relating to the user's prompt 404, network addresses for relevant industrial devices, or other such information. If desired, the user can enter further prompts 404 to refine the dashboard 602 (e.g., “Provide plots for top 5 trends that will provide important insights to the plant engineer that would help improving manufacturing process.”), and the system 302 will add to or modify the dashboard 602 as requested.

In general, natural language prompts 404 requesting a dynamically created HMI dashboard 402 can include, for example, natural language descriptions of desired visualization layouts; references to specific plant facilities, production lines, or automation systems for which the user is requesting information; indications of the type of information the user wishes to know about a specified automation system; a requested format for the requested information (e.g., a time-based plot, a chart, a natural language explanation, etc.); alarm definitions; or other such prompts. When generating a dashboard 402 in response to a user's prompt 404, the HMI generation component 306 can, as needed, invoke the generative AI component 312, which leverages the industry and customer-specific knowledge encoded in the custom models 322, together with responses 506 prompted from the generative AI model 406, to accurately ascertain the user's visualization needs and format the resulting dashboard 402 to address those needs. Dashboard creation tasks that can be performed by the HMI generation component 306 in response to users'natural language prompts 404 can include, but are not limited to, adding suitable graphical objects to the dashboard 402, arranging these graphical objects in a manner determined to best convey the requested information or best satisfy the user's request, determining and configuring data links between animation properties of these objects and corresponding controller data tags or other data sources, or other such dashboard development tasks.

To obtain the device data 604, 606 required to populate and animate a runtime dashboard 602, the system's device interface component 308 can be configured to connect to various types of data sources across a range of communication protocols, including industrial controllers 118 (from which the device interface component 308 can obtain data determined to be relevant to the user's request from the appropriate data tags), digital and analog sensors (e.g., proximity switches, telemetry devices, meters, etc.), variable frequency drives, open platform communications unified architecture (OPCUA) devices, MQ telemetry transport (MQTT) devices, or other such devices and protocols.

Some embodiments of the HMI development and runtime system 302 can also perform analysis on live data 604 and historical data 606 collected from the customer's industrial devices and render results of this analysis on a runtime dashboard 402. This analysis can be performed by the generative AI component 312, which analyzes the collected data 604, 606 based on industrial knowledge encoded in the custom models 322 as well as responses 506 prompted from the generative AI model 406. The system 302 can use this type of analysis to identify trends or patterns in the historical data 606 indicative of a future or predicted performance issue with an industrial device or automation system, predicted failure of an industrial device or mechanical component of the automation system, or other such issues. Using this and other types of analysis, system 302 can serve as an industrial monitoring system capable of performing dynamic monitoring and analysis of a customer's industrial processes, identifying potential or active performance issues or alarm conditions, and assisting users in resolving these issues.

Although the HMI development and runtime system 302 has been depicted herein as residing and executing on a cloud platform for remote access by customers, other architectures can be used to deploy and execute the system 302. For example, the system 302 may be deployed in a hybrid architecture in which the user interface component 304, HMI generation component 306, device interface component 308, HMI runtime component 310, and generative AI component 312 execute on-premise at the customer's facility, while the generative AI model 406 executes on a cloud platform. In such deployment architectures, the system 302 can remotely access the generative AI model 406 from the customer facility, exchanging prompts 504 and responses 506 with the generative AI model 406 as needed to process a user's natural language prompts 404. According to another example deployment architecture, the system 302 can be deployed as a purely on-premise solution in which the system 302 and generative AI model 406 execute on systems that operate at the customer's facility or on one or more edge-level devices.

The HMI development and runtime system 302 described herein can streamline creation of HMI dashboards, reducing development time and cost. This approach also allows line-side operators with no coding or HMI development experience to dynamically create HMI dashboards to help assess ad hoc automation system performance issues. The system 302 can also assist users with data-driven decision-making by using generative AI to glean insights from real-time and historical data generated by the customer's automation systems.

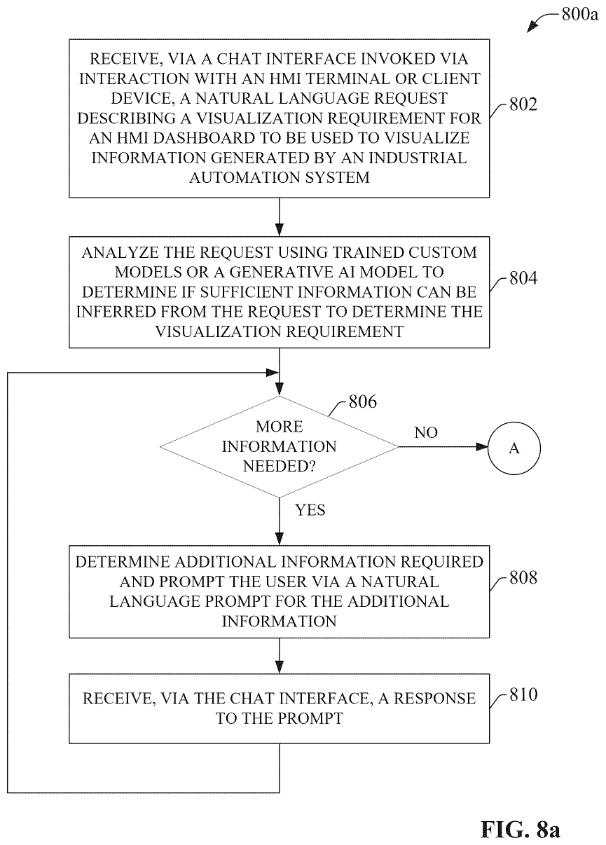

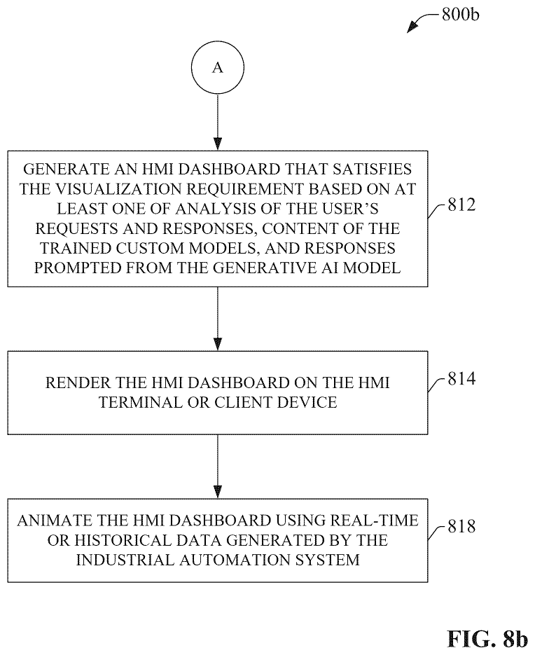

FIGS. 8a-8b illustrate a methodology in accordance with one or more embodiments of the subject application. While, for purposes of simplicity of explanation, the methodology shown herein are shown and described as a series of acts, it is to be understood and appreciated that the subject innovation is not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the innovation. Furthermore, interaction diagram(s) may represent methodologies, or methods, in accordance with the subject disclosure when disparate entities enact disparate portions of the methodologies.

Further yet, two or more of the disclosed example methods can be implemented in combination with each other, to accomplish one or more features or advantages described herein.

FIG. 8a illustrates a first part of an example methodology 800a for generating an HMI dashboard or interface using natural language design input. Initially, at 802, a natural language request describing a visualization requirement for an HMI dashboard is received via a chat interface or another type of natural language interface supported by an HMI development and runtime system. The chat interface can be invoked via an interaction with an HMI terminal device or a client device that remotely interfaces with the HMI development and runtime system. The natural language request can describe substantially any type of request to visualize operational, status, or historical performance information for a specified automation system. For example, the user may submit written or spoken natural language requests to render a time-series plot for a specified sensor or meter that measures a performance indicator for the automation system (e.g., temperature, pressure, speed, energy consumption, emissions, etc.), to render a list of the performance issues experienced by the automation system that are most detrimental to the system's productivity, to render specified performance or key performance indicator statistics for the automation system, or other such natural language input. The natural language request may also describe the functional requirements in more general terms; e.g., by describing the types of information generated by the automation system that the user wishes to see rendered on the HMI dashboard. In some scenarios, the natural language request may reference an existing element or property of an HMI dashboard or interface currently being displayed, such as a graphical object or data link between a graphical object and a data source whose value animates the graphical object (e.g., “Link the fill animation for Tank 2 to the Material 1 Tank Level tag”; “Move Valve 1 to the right side of the screen”, etc.).

At 804, the request received at step 802 is analyzed by the HMI development and runtime system using trained custom models or a generative AI to determine if sufficient information can be inferred from the request to generate an HMI dashboard having a sufficiently high probability of satisfying the visualization requirement. The custom models can be trained using sets of training data representing a range of domain-specific industrial knowledge. Example training data that can be used to train the custom models includes, but is not limited to, information defining industrial standards (e.g., global or vertical-specific safety standards, food and drug standards, design standards such as the ISA-88 standard, etc.), technical specifics or design standards for various types of industrial control applications (e.g., batch control processes, die casting, valve control, agitator control, etc.), knowledge of specific industrial verticals (e.g., automotive, food and beverage, pharmaceuticals, oil and gas, textiles, mining, etc.), knowledge of industrial best practices, technical specifications for various types of industrial devices or assets (e.g., industrial controllers, motor drives such as variable frequency drives, sensors, etc.), control design rules, sample HMI display layouts for various types of control applications or use cases, customer-specific training data describing in-house HMI design preferences or standards (e.g., preferred screen layout formats, preferred types of graphics, preferred text fonts, etc.), or other such training data. As part of the analysis, the system can also generate and submit prompts to the generative AI model and use the content of the generative AI model's responses in connection with analyzing the user's request and generating natural languages responses directed to the user if necessary.

At 806, a determination is made as to whether more information is needed from the user in order to determine the user's visualization requirements and generate a suitable dashboard determined to satisfy these requirements. If additional information is required (YES at step 806), the methodology proceeds to step 808, where the HMI development system determines the additional information required, and renders a natural language prompt designed to guide the user toward providing the additional information. In determining the nature of the necessary additional information, the system can reference the industry knowledge encoded in the trained models as well as responses prompted from the generative AI model. At 810, a response to the prompt generated at step 808 is received via the chat interface.

Steps 806-810 are repeated as a natural language dialog with the user until sufficient information translatable to a set of functional requirements for the requested HMI development action has been obtained. When no further information is required from the user (NO at step 806), the methodology proceeds to the second part 800b illustrated in FIG. 8b. At 812, the HMI development and runtime system generates an HMI dashboard determined to satisfy the visualization requirement based on at least one of analysis of the user's natural language request and responses as obtained at steps 802 and 810, content of the trained custom models, or responses prompted from the generative AI model. At 814, the HMI dashboard generated at step 812 is rendered on the HMI terminal or client device. At 818, graphical elements of the HMI dashboard—such as alphanumeric text, numerical values, animated graphical objects, plots, or other such elements—are animated using real-time or historical data generated by the industrial automation system.

Embodiments, systems, and components described herein, as well as control systems and automation environments in which various aspects set forth in the subject specification can be carried out, can include computer or network components such as servers, clients, programmable logic controllers (PLCs), automation controllers, communications modules, mobile computers, on-board computers for mobile vehicles, wireless components, control components and so forth which are capable of interacting across a network. Computers and servers include one or more processors—electronic integrated circuits that perform logic operations employing electric signals—configured to execute instructions stored in media such as random access memory (RAM), read only memory (ROM), a hard drives, as well as removable memory devices, which can include memory sticks, memory cards, flash drives, external hard drives, and so on.

Similarly, the term PLC or automation controller as used herein can include functionality that can be shared across multiple components, systems, and/or networks. As an example, one or more PLCs or automation controllers can communicate and cooperate with various network devices across the network. This can include substantially any type of control, communications module, computer, Input/Output (I/O) device, sensor, actuator, and human machine interface (HMI) that communicate via the network, which includes control, automation, and/or public networks. The PLC or automation controller can also communicate to and control various other devices such as standard or safety-rated I/O modules including analog, digital, programmed/intelligent I/O modules, other programmable controllers, communications modules, sensors, actuators, output devices, and the like.

The network can include public networks such as the internet, intranets, and automation networks such as control and information protocol (CIP) networks including DeviceNet, ControlNet, safety networks, and Ethernet/IP. Other networks include Ethernet, DH/DH+, Remote I/O, Fieldbus, Modbus, Profibus, CAN, wireless networks, serial protocols, and so forth. In addition, the network devices can include various possibilities (hardware and/or software components). These include components such as switches with virtual local area network (VLAN) capability, LANs, WANs, proxies, gateways, routers, firewalls, virtual private network (VPN) devices, servers, clients, computers, configuration tools, monitoring tools, and/or other devices.

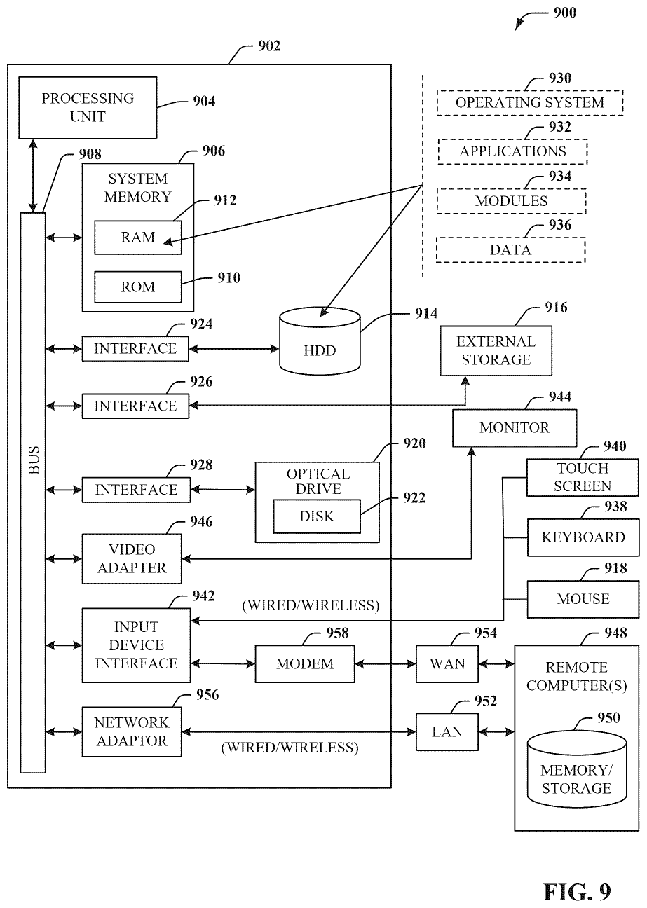

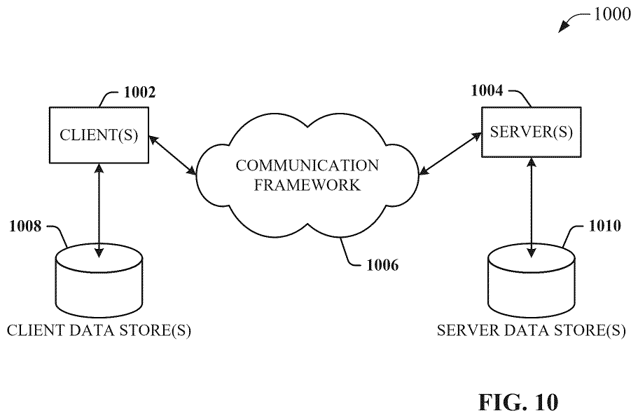

In order to provide a context for the various aspects of the disclosed subject matter, FIGS. 9 and 10 as well as the following discussion are intended to provide a brief, general description of a suitable environment in which the various aspects of the disclosed subject matter may be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 9, the example environment 900 for implementing various embodiments of the aspects described herein includes a computer 902, the computer 902 including a processing unit 904, a system memory 906 and a system bus 908. The system bus 908 couples system components including, but not limited to, the system memory 906 to the processing unit 904. The processing unit 904 can be any of various commercially available processors. Dual microprocessors and other multi-processor architectures can also be employed as the processing unit 904.

The system bus 908 can be any of several types of bus structure that can further interconnect to a memory bus (with or without a memory controller), a peripheral bus, and a local bus using any of a variety of commercially available bus architectures. The system memory 906 includes ROM 910 and RAM 912. A basic input/output system (BIOS) can be stored in a non-volatile memory such as ROM, erasable programmable read only memory (EPROM), EEPROM, which BIOS contains the basic routines that help to transfer information between elements within the computer 902, such as during startup. The RAM 912 can also include a high-speed RAM such as static RAM for caching data.

The computer 902 further includes an internal hard disk drive (HDD) 914 (e.g., EIDE, SATA), one or more external storage devices 916 (e.g., a magnetic floppy disk drive (FDD) 916, a memory stick or flash drive reader, a memory card reader, etc.) and an optical disk drive 920 (e.g., which can read or write from a CD-ROM disc, a DVD, a BD, etc.). While the internal HDD 914 is illustrated as located within the computer 902, the internal HDD 914 can also be configured for external use in a suitable chassis (not shown). Additionally, while not shown in environment 900, a solid state drive (SSD) could be used in addition to, or in place of, an HDD 914. The HDD 914, external storage device(s) 916 and optical disk drive 920 can be connected to the system bus 908 by an HDD interface 924, an external storage interface 926 and an optical drive interface 928, respectively. The interface 924 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth.

For the computer 902, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 912, including an operating system 930, one or more application programs 932, other program modules 934 and program data 936. All or portions of the operating system, applications, modules, and/or data can also be cached in the RAM 912. The systems and methods described herein can be implemented utilizing various commercially available operating systems or combinations of operating systems.

Computer 902 can optionally comprise emulation technologies. For example, a hypervisor (not shown) or other intermediary can emulate a hardware environment for operating system 930, and the emulated hardware can optionally be different from the hardware illustrated in FIG. 9. In such an embodiment, operating system 930 can comprise one virtual machine (VM) of multiple VMs hosted at computer 902. Furthermore, operating system 930 can provide runtime environments, such as the Java runtime environment or the .NET framework, for application programs 932. Runtime environments are consistent execution environments that allow application programs 932 to run on any operating system that includes the runtime environment. Similarly, operating system 930 can support containers, and application programs 932 can be in the form of containers, which are lightweight, standalone, executable packages of software that include, e.g., code, runtime, system tools, system libraries and settings for an application.

Further, computer 902 can be enable with a security module, such as a trusted processing module (TPM). For instance with a TPM, boot components hash next in time boot components, and wait for a match of results to secured values, before loading a next boot component. This process can take place at any layer in the code execution stack of computer 902, e.g., applied at the application execution level or at the operating system (OS) kernel level, thereby enabling security at any level of code execution.

A user can enter commands and information into the computer 902 through one or more wired/wireless input devices, e.g., a keyboard 938, a touch screen 940, and a pointing device, such as a mouse 918. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 904 through an input device interface 944 that can be coupled to the system bus 908, but can be connected by other interfaces, such as a parallel port, an IEEE 1394 serial port, a game port, a USB port, an IR interface, a BLUETOOTH® interface, etc.

A monitor 944 or other type of display device can be also connected to the system bus 908 via an interface, such as a video adapter 946. In addition to the monitor 944, a computer typically includes other peripheral output devices (not shown), such as speakers, printers, etc.

The computer 902 can operate in a networked environment using logical connections via wired and/or wireless communications to one or more remote computers, such as a remote computer(s) 948. The remote computer(s) 948 can be a workstation, a server computer, a router, a personal computer, portable computer, microprocessor-based entertainment appliance, a peer device or other common network node, and typically includes many or all of the elements described relative to the computer 902, although, for purposes of brevity, only a memory/storage device 950 is illustrated. The logical connections depicted include wired/wireless connectivity to a local area network (LAN) 952 and/or larger networks, e.g., a wide area network (WAN) 954. Such LAN and WAN networking environments are commonplace in offices and companies, and facilitate enterprise-wide computer networks, such as intranets, all of which can connect to a global communications network, e.g., the Internet.

When used in a LAN networking environment, the computer 902 can be connected to the local network 952 through a wired and/or wireless communication network interface or adapter 956. The adapter 956 can facilitate wired or wireless communication to the LAN 952, which can also include a wireless access point (AP) disposed thereon for communicating with the adapter 956 in a wireless mode.

When used in a WAN networking environment, the computer 902 can include a modem 958 or can be connected to a communications server on the WAN 954 via other means for establishing communications over the WAN 954, such as by way of the Internet. The modem 958, which can be internal or external and a wired or wireless device, can be connected to the system bus 908 via the input device interface 942. In a networked environment, program modules depicted relative to the computer 902 or portions thereof, can be stored in the remote memory/storage device 950. It will be appreciated that the network connections shown are example and other means of establishing a communications link between the computers can be used.

When used in either a LAN or WAN networking environment, the computer 902 can access cloud storage systems or other network-based storage systems in addition to, or in place of, external storage devices 916 as described above. Generally, a connection between the computer 902 and a cloud storage system can be established over a LAN 952 or WAN 954 e.g., by the adapter 956 or modem 958, respectively. Upon connecting the computer 902 to an associated cloud storage system, the external storage interface 926 can, with the aid of the adapter 956 and/or modem 958, manage storage provided by the cloud storage system as it would other types of external storage. For instance, the external storage interface 926 can be configured to provide access to cloud storage sources as if those sources were physically connected to the computer 902.

The computer 902 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

FIG. 10 is a schematic block diagram of a sample computing environment 1000 with which the disclosed subject matter can interact. The sample computing environment 1000 includes one or more client(s) 1002. The client(s) 1002 can be hardware and/or software (e.g., threads, processes, computing devices). The sample computing environment 1000 also includes one or more server(s) 1004. The server(s) 1004 can also be hardware and/or software (e.g., threads, processes, computing devices). The servers 1004 can house threads to perform transformations by employing one or more embodiments as described herein, for example. One possible communication between a client 1002 and servers 1004 can be in the form of a data packet adapted to be transmitted between two or more computer processes. The sample computing environment 1000 includes a communication framework 1006 that can be employed to facilitate communications between the client(s) 1002 and the server(s) 1004. The client(s) 1002 are operably connected to one or more client data store(s) 1008 that can be employed to store information local to the client(s) 1002. Similarly, the server(s) 1004 are operably connected to one or more server data store(s) 1010 that can be employed to store information local to the servers 1004.

What has been described above includes examples of the subject innovation. It is, of course, not possible to describe every conceivable combination of components or methodologies for purposes of describing the disclosed subject matter, but one of ordinary skill in the art may recognize that many further combinations and permutations of the subject innovation are possible. Accordingly, the disclosed subject matter is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the disclosed subject matter. In this regard, it will also be recognized that the disclosed subject matter includes a system as well as a computer-readable medium having computer-executable instructions for performing the acts and/or events of the various methods of the disclosed subject matter.

In addition, while a particular feature of the disclosed subject matter may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

In this application, the word “exemplary” is used to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.

Various aspects or features described herein may be implemented as a method, apparatus, or article of manufacture using standard programming and/or engineering techniques. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips...), optical disks [e.g., compact disk (CD), digital versatile disk (DVD) . . . ], smart cards, and flash memory devices (e.g., card, stick, key drive . . . ).

What is claimed is:

1. A system, comprising:
a memory that stores executable components; and
a processor, operatively coupled to the memory, that executes the executable components, the executable components comprising:
a user interface component configured to render a chat interface on a client device and to receive, via interaction with the chat interface, a natural language prompt that describes a visualization requirement for rendering operational or status information about an industrial automation system;
a generative artificial intelligence (AI) component configured to, in response to receipt of the natural language prompt, formulate a human-machine interface (HMI) dashboard that satisfies the visualization requirement based on analysis of the natural language prompt and content of one or more custom models trained with training data, wherein the HMI dashboard defines a display screen, a layout of graphical objects on the display screen, and communication links between the graphical objects and corresponding sources of data generated by an industrial automation system;
an HMI generation component configured to render the HMI dashboard on the client device; and
a device interface component configured to read data from the sources of data and visualize the data on the HMI dashboard via the graphical objects.

2. The system of claim 1, wherein the training data comprises at least one of information defining industrial standards, technical specifics for respective types of industrial control applications, knowledge of respective industrial verticals, information describing industrial best practices, technical specifications for different types of industrial devices or machines, control design rules, sample HMI display layouts for respective types of control applications, or customer-specific training data describing in-house HMI design preferences.

3. The system of claim 1, wherein the natural language design input describes at least one of a visualization layout to be implemented by HMI dashboard, industrial assets of the industrial automation system whose data is to be rendered on the HMI dashboard, an alarm requirement of the HMI dashboard, a source of data that is to control an animation property of one of the graphical objects, an indication of a plant facility in which the industrial automation system operates, an indication of a production line on which the industrial automation system operates, an indication of the automation system to be visualized on the HMI dashboard, or a format in which the operational or status information is to be rendered on the HMI dashboard.

4. The system of claim 1, wherein the generative AI component is further configured to, in response to receipt of the natural language prompt, formulate a prompt, directed to a generative AI model, designed to obtain a response from the generative AI model comprising information used by the generative AI component to at least one of determine the visualization requirement or formulate the HMI dashboard, wherein the prompt is formulated based on analysis of the natural language prompt and the content of one or more custom models.

5. The system of claim 1, wherein the generative AI component is further configured to, in response to determining, based on analysis of the natural language prompt, that additional information will allow the generative AI component to formulate an HMI dashboard having a probability of satisfying the visualization requirement that exceeds a threshold,
generate a natural language response that prompts for the additional information,
render the natural language response via the user interface component, and
formulate the HMI dashboard based on analysis of the natural language prompt, the content of the one or more custom models, and the additional information.

6. The system of claim 1, wherein the generative AI component is further configured to render, on the HMI dashboard, a natural language insight regarding operation of the industrial automation system deemed relevant to the natural language prompt based on analysis of the natural language prompt and the data read from the sources of data.

7. The system of claim 6, wherein the natural language insight comprises at least one of information regarding functional relationships between industrial assets, an identity of a sensor or meter that generates information requested by the natural language prompt, a communication protocol used for data communication between industrial devices or assets relating to the natural language prompt, or a network address for an industrial device relevant to the natural language prompt.

8. The system of claim 1, wherein the visualization requirement described by the natural language prompt is at least one of a request to plot a time-series performance metric of the industrial automation system, a request to render information regarding a subset of performance issues experienced determined to be most detrimental to productivity of the industrial automation system, or a request to render statistics for a specified key performance indicator of the industrial automation system.

9. The system of claim 1, wherein the generative AI component is configured to, based on the analysis of the natural language prompt and the content of the one or more custom models, formulate at least one of content of the HMI dashboard, a layout of the content, a link between an animated graphic of the HMI dashboard and a source of data that is to animate the animated graphic, an alarm definition for rendering an alarm on the dashboard, or a color setting for the HMI dashboard.

10. A method, comprising:
rendering, by a system comprising a processor, a chat interface on a client device;
receiving, by the system via interaction with the chat interface, a natural language prompt describing a visualization requirement for rendering operational or status information about an industrial automation system;
in response to the receiving of the natural language prompt, formulating, by the system, a human-machine interface (HMI) dashboard that satisfies the visualization requirement based on analysis of the natural language prompt and content of one or more custom models trained with training data, wherein the HMI dashboard defines a display screen, a layout of graphical objects on the display screen, and communication links between the graphical objects and corresponding sources of data generated by an industrial automation system;
rendering, by the system, the HMI dashboard on the client device; and
rendering, by the system, data items read from the sources of data on the HMI dashboard via the graphical objects.

11. The method of claim 10, wherein the training data comprises at least one of information defining industrial standards, technical specifics for respective types of industrial control applications, knowledge of respective industrial verticals, information describing industrial best practices, technical specifications for different types of industrial devices or machines, control design rules, sample HMI display layouts for respective types of control applications, or customer-specific training data describing in-house HMI design preferences.

12. The method of claim 10, wherein the natural language design input describes at least one of a visualization layout to be implemented by HMI dashboard, industrial assets of the industrial automation system whose data is to be rendered on the HMI dashboard, an alarm requirement of the HMI dashboard, a source of data that is to control an animation property of one of the graphical objects, an indication of a plant facility in which the industrial automation system operates, an indication of a production line on which the industrial automation system operates, an indication of the automation system to be visualized on the HMI dashboard, or a format in which the operational or status information is to be rendered on the HMI dashboard.

13. The method of claim 10, further comprising, in response to receipt of the natural language prompt, formulating, by the system, a prompt, directed to a generative AI model, designed to obtain a response from the generative AI model comprising information used by the system to at least one of determine the visualization requirement or formulate the HMI dashboard, wherein the prompt is formulated based on analysis of the natural language prompt and the content of one or more custom models.

14. The method of claim 10, further comprising, in response to determining, based on analysis of the natural language prompt, that additional information will allow the system to formulate an HMI dashboard having a probability of satisfying the visualization requirement that exceeds a threshold:
generating, by the system, a natural language response that prompts for the additional information;
rendering, by the system, the natural language response via the user interface component; and
formulating, by the system, the HMI dashboard based on analysis of the natural language design input, the content of the one or more custom models, and the additional information.

15. The method of claim 10, further comprising:
generating, by the system, a natural language insight regarding operation of the industrial automation system deemed relevant to the natural language prompt based on analysis of the natural language prompt and the data read from the sources of data; and
rendering, by the system, the natural language insight on the HMI dashboard.

16. The method of claim 15, wherein the natural language insight comprises at least one of information regarding functional relationships between industrial assets, an identity of a sensor or meter that generates information requested by the natural language prompt, a communication protocol used for data communication between industrial devices or assets relating to the natural language prompt, or a network address for an industrial device relevant to the natural language prompt.

17. The method of claim 10, wherein the visualization requirement described by the natural language prompt is at least one of a request to plot a time-series performance metric of the industrial automation system, a request to render information regarding a subset of performance issues experienced determined to be most detrimental to productivity of the industrial automation system, or a request to render statistics for a specified key performance indicator of the industrial automation system.

18. The method of claim 10, wherein the formulating comprises configuring at least one of content of the HMI dashboard, a layout of the content, a link between an animated graphic of the HMI dashboard and a source of data that is to animate the animated graphic, an alarm definition for rendering an alarm on the dashboard, or a color setting for the HMI dashboard.

19. A non-transitory computer-readable medium having stored thereon instructions that, in response to execution, cause a system comprising a processor to perform operations, the operations comprising:
rendering a chat interface on a client device;
receiving, via interaction with the chat interface, a natural language prompt describing a visualization requirement for rendering operational or status information about an industrial automation system;
in response to the receiving of the natural language prompt, formulating a human-machine interface (HMI) dashboard that satisfies the visualization requirement based on analysis of the natural language prompt and content of one or more custom models trained with training data, wherein the HMI dashboard defines a display screen, a layout of graphical objects on the display screen, and communication links between the graphical objects and corresponding sources of data generated by an industrial automation system;
rendering the HMI dashboard on the client device; and
rendering data items read from the sources of data on the HMI dashboard via the graphical objects.

20. The non-transitory computer-readable medium of claim 19, wherein the natural language design input describes at least one of a visualization layout to be implemented by HMI dashboard, industrial assets of the industrial automation system whose data is to be rendered on the HMI dashboard, an alarm requirement of the HMI dashboard, a source of data that is to control an animation property of one of the graphical objects, an indication of a plant facility in which the industrial automation system operates, an indication of a production line on which the industrial automation system operates, an indication of the automation system to be visualized on the HMI dashboard, or a format in which the operational or status information is to be rendered on the HMI dashboard.
